(19) United States
(12) Patent Application Publication
(10) Pub. No.: US 2017/0208334 A1
(43) Pub. Date: Jul. 20, 2017

(54) METHOD AND APPARATUS FOR PROCESSING IMAGE DATA

(71) Applicants: Samsung Electronics Co., Ltd, Gyeonggi-do (KR); Research & Business Foundation Sungkyunkwan University, Gyeonggi-do (KR)

(72) Inventors: Min-Ju Yoo, Gyeonggi-do (KR); Byeongwoo Jeon, Gyeonggi-do (KR); Bong-Soo Jung, Gyeonggi-do (KR)

(21) Appl. No.: 15/404,157

(22) Filed: Jan. 11, 2017

(30) Foreign Application Priority Data
Jan. 19, 2016 (KR) 10-2016-0006685

(51) Int. Cl. H04N 19/156; H04N 19/59; H04N 19/136; H04N 19/70; H04N 19/176

(52) U.S. Cl. CPC H04N 19/156; H04N 19/70; H04N 19/176; H04N 19/136; H04N 19/59

(57) ABSTRACT

An electronic device for processing image data may include a memory configured to store image data and a resource state of the electronic device. A processor may be configured to determine a division type of the image data based on the image data and the resource state, divide the image data into at least one data block according to the determined division type, and generate one file by encoding the at least one divided data block. In some embodiments, the processor may be configured to analyze complexity of the image data, and determine the division type based on the complexity. For example, the processor may be configured to divide the image data into a predetermined number of areas if the image data has a low threshold complexity, and divide the image data into a plurality of areas based on the complexity if the complexity is higher than the low threshold.

### CROSS-REFERENCE TO RELATED APPLICATION(S) AND CLAIM OF PRIORITY

The present application is related to and claims priority under 35 U.S.C. §119(a) to Korean Application Serial No. 10-2016-0006685, which was filed in the Korean Intellectual Property Office on Jan. 19, 2016, the entire content of which is hereby incorporated by reference.

### TECHNICAL FIELD

The present disclosure relates to a method and an apparatus for processing image data.

### BACKGROUND

As the demand of high definition services for ultra high definition images such as 8K Ultra High Definition (UHD) increases, commercialization of ultra high definition multimedia content services such as 8K UHD will start in various application fields in the not so distant future. Further, ultra high definition images such as 8K UHD may be frequently used in digital cinema, medical imaging, and satellite imaging fields that are classified as professional fields as well as digital broadcasting and video streaming.

### SUMMARY

As described above, high definition images such as 8K UHD have a larger amount of data compared to the conventional resolution. Further, an S/W (software) encoder/decoder has large current consumption and a low processing speed in processing a high definition and high resolution image. Accordingly, by using an H/W (hardware) encoder/decoder, an effect of a higher processing speed and lower current consumption can be acquired.

However, in order to process massive data of the high definition image such as 8K UHD through a H/W encoder/decoder included in a current portable terminal, hardware specification of a multimedia processing component of the portable terminal should support 8K UHD. Therefore, the massive data of the high definition image such as 8K UHD can be processed after a considerable development term. Further, in order to receive a high definition image service, a considerable amount of time is consumed until the replacement of image equipment since medical image equipment or satellite photo display device are expensive.

The conventional method of processing a high definition image, which cannot be supported by the portable terminal, includes a method of dividing the high definition image into images having a size which can be supported by the portable terminal, and encoding/decoding the divided images. However, the method should repeatedly encode the divided high definition images on every frame by assigning a task handler for an individual encoding/decoding to each of the frames and then close the encoding handler in order to encode/decode the divided high definition images. Further, there is a method of encoding/decoding several frames in parallel, but the method opens and closes many encoding/decoding handlers to encode/decode only some frames, thereby wasting resources.

Various embodiments of the present disclosure may provide a method and an apparatus for processing image data which can encode and decode high definition and high resolution image data that is not supported by the electronic device through the H/W encoder/decoder of the electronic device.

According to various embodiments of the present disclosure, an electronic device is provided. The electronic device includes: a memory configured to store image data and a resource state of the electronic device; and a processor, and the processor may be configured to determine a division type of the image data based on the image data and the resource state of the electronic device, to divide the image data into at least one data block according to the determined division type, and to generate one file by encoding the at least one divided data block.

According to various embodiments of the present disclosure, an electronic device may include: an encoding module; and a processor, and the processor may be configured to identify a characteristic of image data from the image data, to divide the image data into a first number of areas through a first method when the characteristic meets a first condition, to divide the image data into a second number of areas through a second method when the characteristic meets a second condition, and to generate video encoding streams corresponding to the image data by using one corresponding method between the first method and the second method through the encoding module.

According to various embodiments of the present disclosure, a method of processing image data by an electronic device is provided. The method includes: an operation of determining a division type of the image data based on the image data and a resource state of the electronic device by the electronic device; an operation of dividing the image data into at least one data block according to the determined division type; and an operation of generating one file by encoding the at least one divided data block.

According to various embodiments of the present disclosure, a computer recording medium executed by at least one processor and storing computer-readable instructions is provided. The instructions include: determining a division type of image data based on the image data and a resource state of an electronic device; dividing the image data into at least one data block according to the determined division type; and generating one file by encoding the at least one divided data block.

According to various embodiments of the present disclosure, it is possible to process high definition and high resolution image data which, is not supported by an electronic device, through an H/W encoder/decoder of the electronic device. Further, by performing optimal image data processing according to a resource state of the electronic device, it is possible to not only process high definition and high resolution image data through limited resources of the electronic device but also reduce current consumption according to image data processing and improve speed and compression efficiency of the image data processing.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device within a network environment according to various embodiments of the present disclosure;

FIG. 2 illustrates a block diagram of an electronic device according to various embodiments of the present disclosure;

FIG. 3 illustrates a block diagram of a program module according to various embodiments of the present disclosure;

FIG. 4 is a block diagram illustrating an electronic device for processing image data according to various embodiments of the present disclosure;

FIG. 5 illustrates a sub sampling division type of image data according to various embodiments of the present disclosure;

FIG. 6 illustrates a method of reconfiguring divided data blocks of image data into video streams according to various embodiments of the present disclosure;

FIG. 7 is a flowchart illustrating a method of processing image data according to various embodiments of the present disclosure; and

FIG. 8 is a flowchart illustrating a method of determining a division type of image data according to various embodiments of the present disclosure.

### DETAILED DESCRIPTION

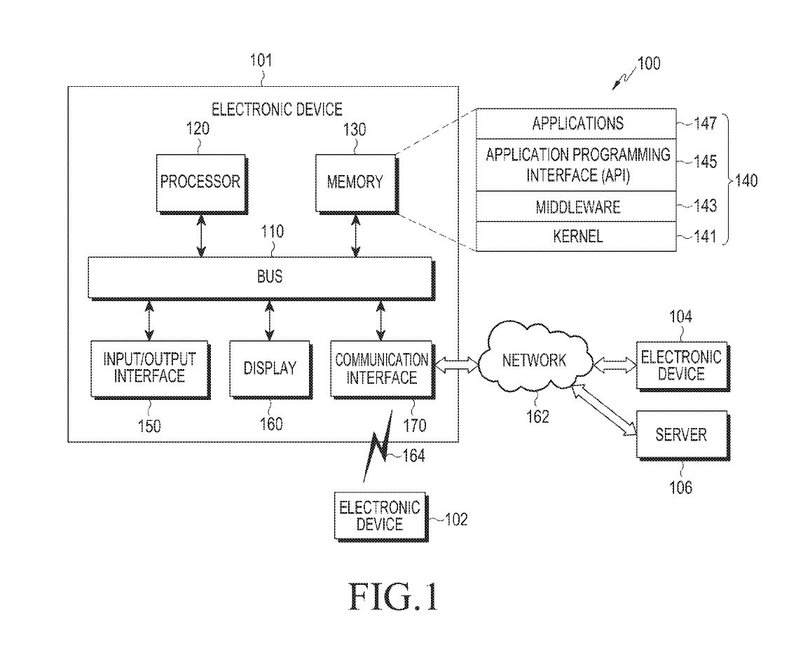

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MM), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

FIG. 1 is a block diagram illustrating an electronic device 101 within a network environment 100 according to various embodiments.

Referring to FIG. 1, the electronic device 101 may include a bus 110, a processor 120, a memory 130, an input/output interface 150, a display 160, and a communication interface 170. In some embodiments, the electronic device 101 may omit at least some of the above elements or further include other elements.

The bus 110 may include, for example, a circuit for connecting the components and transmitting communication between the elements (for example, control messages and/or data).

The processor 120 may include one or more of a Central Processing Unit (CPU), an Application Processor (AP), and a Communication Processor (CP). The processor 120, for example, may carry out operations or data processing relating to the control and/or communication of at least one other element of the electronic device 101.

The memory 130 may include a volatile and/or non-volatile memory. The memory 130 may store, for example, instructions or data relevant to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data.

Furthermore, the middleware 143 may process one or more task requests, which are received from the application programs 147, according to priorities thereof. For example, the middleware 143 may assign priorities for using the system resources (for example, the bus 110, the processor 120, the memory 130, and the like) of the electronic device 101 to one or more of the application programs 147. For example, the middleware 143 may perform scheduling or load balancing on the one or more task requests by processing the one or more task requests according to the priorities assigned to the one or more application programs.

The API 145, which is an interface through which the applications 147 control functions provided from the kernel 141 or the middleware 143, may include, for example, at least one interface or function (for example, an instruction) for file control, window control, image processing, text control, and the like.

The input/output interface 150 may function as, for example, an interface that may forward instructions or data, which is input from a user or another external device, to the other element(s) of the electronic device 101. Furthermore, the input/output interface 150 may output instructions or data, which are received from the other element(s) of the electronic device 101, to the user or the external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (for example, text, images, videos, icons, symbols, and the like) for a user. The display 160 may include a touch screen and may receive, for example, a touch, gesture, proximity, or hovering input using an electronic pen or the user's body part.

The communication interface 170 may configure communication, for example, between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may use, for example, at least one of Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), Global System for Mobile Communications (GSM), and the like, as a cellular communication protocol. In addition, the wireless communication may include, for example, short range communication 164. The short range communication 164 may include, for example, at least one of WiFi, Bluetooth®, Near Field Communication (NFC), Global Navigation Satellite System (GNSS), and the like. The GNSS may include at least one of, for example, a Global Positioning System (GPS), a Global Navigation Satellite System (Glonass®), a Beidou® Navigation Satellite System (hereinafter referred to as “Beidou”), and a European Global Satellite-based Navigation System (Galileo®), according to a use area, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a communication network such as a computer network (for example, a LAN or a WAN), the Internet, and a telephone network.

Each of the first and second external electronic devices 102 and 104 may be of a type identical to or different from that of the electronic device 101. According to an embodiment, the server 106A may include a group of one or more servers. According to various embodiments, all or some of the operations performed by the electronic device 101 may be performed by another electronic device or a plurality of electronic devices (for example, the electronic device 102 or 104 or the server 106). According to an embodiment, when the electronic device 101 should perform some functions or services automatically or by request, the electronic device 101 may make a request for performing at least some of the functions related to the functions or services to another device (for example, the electronic device 102 or 104 or the server 106) instead of performing the functions or services by itself. Another electronic device (for example, the electronic device 102 or 104 or the server 106) may execute the requested functions or the additional functions, and may deliver a result of the execution to the electronic device 101. The electronic device 101 may provide the received result as it is or additionally process the received result and provide the requested functions or services. To this end, for example, cloud computing, distributed computing, or client-server computing technology may be used.

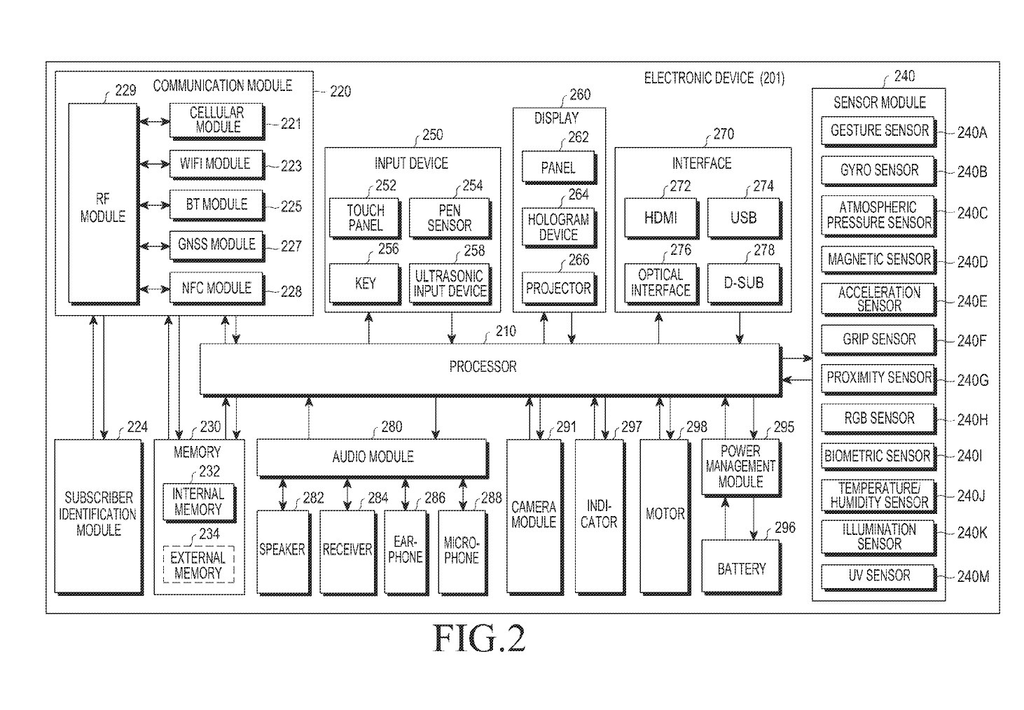

FIG. 2 is a block diagram of the electronic device according to various embodiments.

The electronic device 201 may include, for example, the whole or part of the electronic device 101 illustrated in FIG. 1. The electronic device 201 may include at least one Application Processor (AP) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software elements connected thereto and may perform various data processing and operations by driving an operating system or an application program. The processor 210 may be embodied, for example, as a System on Chip (SoC). According to an embodiment, the processor 210 may further include a Graphic Processing Unit (GPU) and/or an image signal processor. The processor 210 may also include at least some (for example, a cellular module 221) of the elements illustrated in FIG. 2. The processor 210 may load, in a volatile memory, instructions or data received from at least one of the other elements (for example, a non-volatile memory) to process the loaded instructions or data, and may store various types of data in the non-volatile memory.

The communication module 220 may have a configuration equal or similar to that of the communication interface 170 of FIG. 1. The communication module 220 may include, for example, a cellular module 221, a Wi-Fi module 223, a Bluetooth® module 225, a GNSS module 227, an NFC module 228, and a Radio Frequency (RF) module 229.

The cellular module 221 may provide, for example, a voice call, a video call, a text message service, an Internet service, and the like through a communication network. According to an embodiment, the cellular module 221 may identify and authenticate the electronic device 201 within a communication network using a subscriber identification module (for example, the SIM card 224). According to an embodiment, the cellular module 221 may perform at least some of the functions that the processor 210 may provide. According to an embodiment, the cellular module 221 may include a Communication Processor (CP).

The Wi-Fi module 223, the BT module 225, the GNSS module 227, or the NFC module 228 may include, for example, a processor for processing data that is transmitted and received through the corresponding module. According to some embodiments, at least some (two or more) of the cellular module 221, the Wi-Fi module 223, the Bluetooth® module 225, the GNSS module 227, and the NFC module 228 may be included in one Integrated Chip (IC) or IC package.

The RF module 229, for example, may transmit/receive a communication signal (for example, an RF signal). The RF module 229 may include, for example, a transceiver, a Power Amplifier Module (PAM), a frequency filter, a Low Noise Amplifier (LNA), an antenna, and the like. According to another embodiment, at least one of the cellular module 221, the Wi-Fi module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 230 (for example, the memory 130) may include, for example, an internal memory 232 or an external memory 234. The internal memory 232 may include, for example, at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory, a NOR flash memory, and the like), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 234 may be functionally or physically connected to the electronic device 201 through various interfaces.

The sensor module 240 may, for example, measure a physical quantity or detect the operating state of the electronic device 201 and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some embodiments, the electronic device 201 may further include a processor configured to control the sensor module 240 as a part of or separately from the AP 210, and may control the sensor module 240 while the AP 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. Furthermore, the touch panel 252 may further include a control circuit. The touch panel 252 may further include a tactile layer to provide a tactile reaction to a user.

The (digital) pen sensor 254 may include, for example, a recognition sheet which is a part of the touch panel or is separated from the touch panel. The key 256 may include, for example, a physical button, an optical key, or a keypad. The ultrasonic input unit 258 may input data through an input means that generates an ultrasonic signal, and the electronic device 201 identify data by detecting a sound wave with a microphone (for example, a microphone 288).

The display 260 (for example, the display 160) may include a panel 262, a hologram device 264 or a projector 266. The panel 262A may include the same or a similar configuration to the display 160A illustrated in FIG. 1. The panel 262 may be implemented to be, for example, flexible, transparent, or wearable. The panel 262, together with the touch panel 252, may be implemented as one module. The hologram device 264 may show a three dimensional image in the air by using interference of light. The projector 266 may display an image by projecting light onto a screen. The screen may be located, for example, in the interior of, or on the exterior of, the electronic device 201. According to one embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included, for example, in the communication interface 170 illustrated in FIG. 1. Additionally or alternatively, the interface 270 may, for example, include a mobile high-definition link (MHL) interface, a secure digital (SD) card/multi-media card (MMC) interface, or an infrared data association (IrDA) standard interface.

The audio module 280 may convert, for example, a sound into an electrical signal, and vice versa. At least some elements of the audio module 280 may be included, for example, in the input/output interface 150 illustrated in FIG. 1. The audio module 280 may process sound information that is input or output through, for example, a speaker 282, a receiver 284, earphones 286, the microphone 288, and the like.

The camera module 291 is a device which may photograph a still image and a dynamic image. According to an embodiment, the camera module 291 may include one or more image sensors (for example, a front sensor or a back sensor), a lens, an Image Signal Processor (ISP) or a flash (for example, LED or xenon lamp).

The power management module 295 may manage, for example, the power of the electronic device 201. According to an embodiment, the power management module 295 may include a Power Management Integrated Circuit (PMIC), a charger Integrated Circuit (IC), or a battery or fuel gauge. The PMIC may have a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state, for example, a booting state, a message state, a charging state, or the like of the electronic device 201 or a part (for example, the processor 210) of the electronic device 201. The motor 298 may convert an electrical signal into a mechanical vibration and may generate a vibration, a haptic effect, and the like. Although not illustrated, the electronic device 201 may include a processing unit (for example, a GPU) for supporting mobile TV. The processing unit for supporting mobile TV may, for example, process media data according to a certain standard such as Digital Multimedia Broadcasting (DMB), Digital Video Broadcasting (DVB), or MediaFlo®.

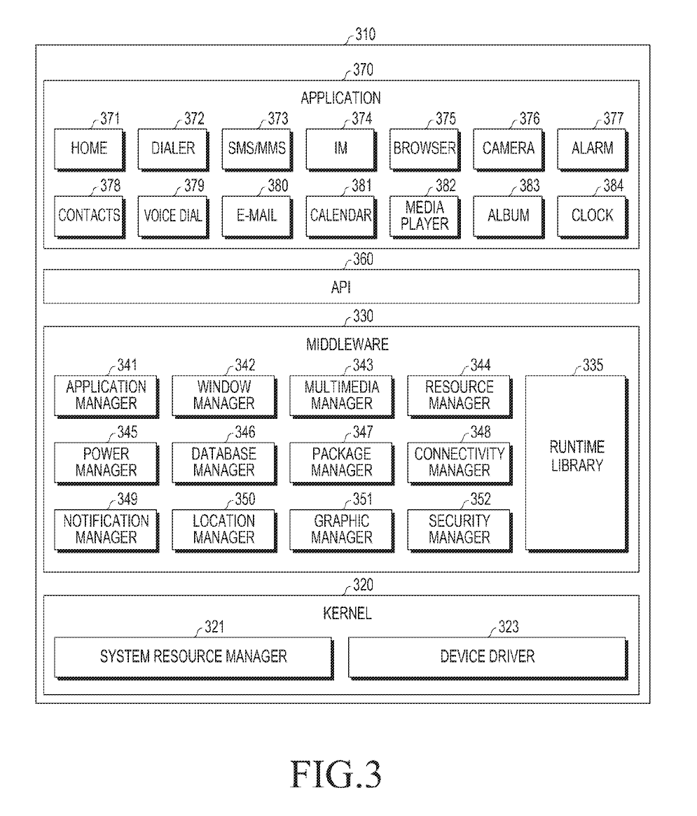

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Further, some of the components of the electronic device according to the various embodiments of the present disclosure may be combined to form a single entity, and thus, may equivalently execute functions of the corresponding elements prior to the combination. FIG. 3 is a block diagram of a program module according to various embodiments.

According to an embodiment, a program module 310 (for example, the program 140) may include an Operating System (OS) for controlling resources related to the electronic device (for example, the electronic device 101) and/or various applications (for example, the application programs 147) executed in the operating system. The operating system may be, for example, Android®, iOS®, Windows®, Symbian®, Tizen®, Bada®, and the like

The program module 310 may include a kernel 320, middleware 330, an Application Programming Interface (API) 360, and/or applications 370. At least some of the program module 310 may be preloaded on an electronic device, or may be downloaded from an external electronic device (for example, the electronic device 102 or 104, or the server 106).

The kernel 320 (for example, the kernel 141) may include, for example, a system resource manager 321 and/or a device driver 323. The system resource manager 321 may control, allocate, or retrieve system resources. According to an embodiment, the system resource manager 321 may include a process manager, a memory manager, or a file system manager. The device driver 323 may include, for example, a display driver, a camera driver, a Bluetooth® driver, a shared memory driver, a USB driver, a keypad driver, a Wi-Fi driver, an audio driver, or an Inter-Process Communication (IPC) driver.

The middleware 330 may provide, for example, a function required by the applications 370 in common, or may provide various functions to the applications 370 through the API 360 such that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses in order to add a new function through a programming language while the applications 370 are being executed. The runtime library 335 may perform input/output management, memory management, the functionality for an arithmetic function, and the like.

The application manager 341 may manage, for example, the life cycle of at least one of the applications 370. The window manager 342 may manage Graphical User Interface (GUI) resources used on a screen. The multimedia manager 343 may determine formats required to reproduce various media files and may encode or decode a media file using a coder/decoder (codec) appropriate for the corresponding format. The resource manager 344 may manage resources, such as a source code, a memory, a storage space, and the like of at least one of the applications 370.

The power manager 345 may operate together with, for example, a Basic Input/Output System (BIOS) to manage a battery or power and provide power information required for the operation of the electronic device. The database manager 346 may generate, search for, and/or change a database to be used by at least one of the applications 370. The package manager 347 may manage the installation or update of an application that is distributed in the form of a package file.

The connectivity manager 348 may manage a wireless connection, such as Wi-Fi, Bluetooth, and the like. The notification manager 349 may display or notify an event, such as an arrival message, an appointment, a proximity notification, and the like, in such a manner as not to disturb a user. The location manager 350 may manage location information of the electronic device. The graphic manager 351 may manage a graphic effect to be provided to a user and a user interface relating to the graphic effect. The security manager 352 may provide various security functions required for system security, user authentication, and the like. According to an embodiment, in a case where the electronic device (for example, the electronic device 101) has a telephone call function, the middleware 330 may further include a telephony manager for managing a voice or video call function of the electronic device.

The middleware 330 may include a middleware module that forms a combination of various functions of the above-described elements. The middleware 330 may provide specialized modules according to the types of operating systems in order to provide differentiated functions. Furthermore, the middleware 330 may dynamically remove some of the existing elements, or may add new elements.

The API 360 (for example, the API 145) is, for example, a set of API programming functions, and may be provided with different configurations according to operating systems. For example, operating systems such as Android® or iOS®, may have one API set provided for each platform, and for a Tizen® operating system, two or more API sets may be provided for each platform.

The applications 370 (for example, the application programs 147) may include, for example, one or more applications which can provide functions such as home 371, dialer 372, SMS/MMS 373, Instant Message (IM) 374, browser 375, camera 376, alarm 377, contacts 378, voice dial 379, email 380, calendar 381, media player 382, album 383, clock 384, health care (for example, measure exercise quantity or blood sugar), or environment information (for example, atmospheric pressure, humidity, or temperature information).

According to an embodiment, the applications 370 may include an application (hereinafter, referred to as an “information exchange application” for convenience of description) that supports information exchange between the electronic device (for example, the electronic device 101) and an external electronic device (for example, the electronic device 102 or 104). The information exchange application may include, for example, a notification relay application for transferring specific information to an external electronic device or a device management application for managing an external electronic device.

For example, the notification relay application may include a function of delivering, to the external electronic device (for example, the electronic device 103 or 104), notification information generated by other applications (for example, an SMS/MMS application, an email application, a health care application, an environmental information application, and the like) of the electronic device 101. Furthermore, the notification relay application may, for example, receive notification information from the external electronic device and may provide the received notification information to a user.

The device management application may manage (for example, install, delete, or update), for example, at least one function of an external electronic device (for example, the electronic device 102 or 104) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an embodiment, the applications 370 may include an application (for example, a health care application of a mobile medical device or the like) designated according to an attribute of the external electronic device (for example, the electronic device 102 or 104). According to an embodiment, the applications 370 may include an application received from the external electronic device (for example, the server 106, or the electronic device 102 or 104). According to an embodiment, the applications 370 may include preloaded applications or third-party applications that can be downloaded from a server. Names of the elements of the program module 310, according to the above-described embodiments of the present disclosure, may change depending on the type of OS.

According to various embodiments, at least some of the program module 310 may be implemented in software, firmware, hardware, or a combination of two or more thereof. At least a part of the program module 310 may be implemented (for example, executed) by, for example, a processor (for example, the processor 120). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented.

For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may, for example, be the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

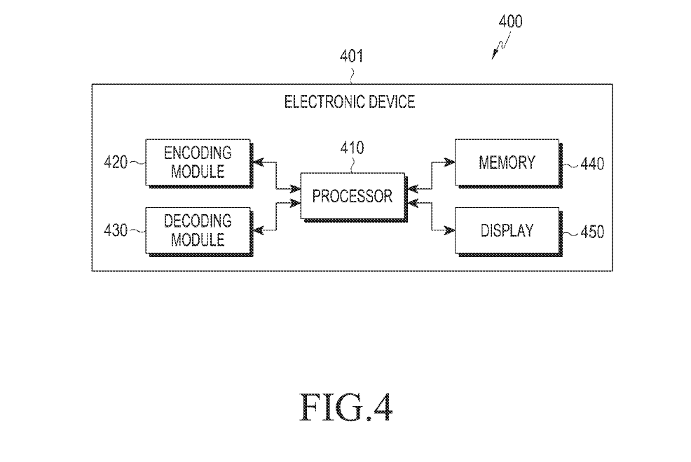

FIG. 4 is a block diagram 400 illustrating an electronic device for processing image data according to various embodiments of the present disclosure.

Referring to FIG. 4, an electronic device 401 according to various embodiments of the present disclosure may include, for example, all or some of the electronic device 101 illustrated in FIG. 1, and may include a processor 410, an encoding module 420, a decoding module 430, a memory 440, and a display 450.

According to various embodiments, the processor 410 may perform at least one function or at least one operation performed by the processor 120 illustrated in FIG. 1. The processor 410 may include a combination of two or more of, for example, hardware, software, and firmware. The processor 410 may include, for example, all or some of the processor 210 illustrated in FIG. 2. The processor 410 may include one or more of a Central Processing Unit (CPU), an Application Processor (AP), and a Communication Processor (CP). The processor 410 may process at least some of the information acquired from other elements of the electronic device 401 (for example, the encoding module 420, the decoding module 430, the memory 440, and the display 450) and provide the information to the user through various methods. According to various embodiments of the present disclosure, the processor 410 may control all elements of the electronic device 401.

According to various embodiments, when a resolution of image data is higher than or equal to a reference resolution (for example, a resolution supported by the electronic device), the processor 410 may allow the image data to have the resolution supportable by the electronic device by dividing the image data into one or more data blocks. For example, the size of the data block is the data unit such as 8×8, 16×16, 32×32, 64×64, 128×128, or 256×256, and may be a square data block having horizontal and vertical sizes of a nth power of two (n=3, 4, 5, 6, 7, 8, . . . ).

According to an embodiment, when it is determined that the resolution of the image data is higher than or equal to the reference resolution, the processor 410 may divide the image data into a predetermined number of pieces of image data. For example, as shown in equation (1) below, the image data may be divided into pieces of image data corresponding to a number rounded up from a value generated by dividing a larger value between the width and the height of the resolution of the image data by a larger value between the width and the height of the predefined reference resolution.

$$number of partitioning = ceil ( \frac{MAX ( W , H )}{MAX ( w , h )} ) \qquad ( 1 )$$

W, H: width and height of resolution of image data

w, h: width and height of reference resolution

ceil: rounded up

For example, when the image data is an 8K Ultra High Definition (UHD) image having a resolution of 7680×4320 and the reference resolution is 1920×1080, the image data may be divided into 4 pieces of image data corresponding to a number rounded up from a value generated by dividing the width 7680, which is the larger value between the width 7680 and the height 4320 of the resolution of the image data, by the width 1920, which is the larger value between the width 1920 and the height 1080.

According to various embodiments, when it is determined that the resolution of the image data is higher than or equal to the reference resolution, the processor 410 may determine a division type of the image data based on the image data and a state of at least one resource of the electronic device 401.

According to an embodiment, the processor 410 may identify the state of at least one resource of the electronic device and determine the division type of the image data based on a result of the identification. The state of at least one resource of the electronic device may include at least one of a temperature of at least some areas of the electronic device (for example, CPU temperature), a memory access type (for example, SRAM type or DRAM type), or a number of executed encoder instances. For example, when the CPU temperature of the electronic device exceeds a reference temperature or when the number of executed encoder instances exceeds a reference number, the processor 410 may increase the number of divisions of the image data. This is to reduce the size of the data block in order to relatively reduce the image data processing load since it may be determined that the electronic device is generally overloaded when the CPU temperature is high or when the number of encoder instances is large. Alternatively, when the memory access type is a Static Random Access Memory (SRAM) type, the processor 410 may determine, as the division type of the image data, a type of dividing the image data sequentially in a horizontal or vertical direction or a type of dividing the image data based on sub sampling. This is because the SRAM corresponds to a type of sequentially reading data and is to relatively reduce the image data processing load since a speed of the image data processing may decrease when complexity of the image data processing is high. Alternatively, when the memory access type is a Dynamic Random Access Memory (DRAM) type, the processor 410 may determine, as the division type of the image data, a type of dividing the image data based on complexity. This is because the DRAM corresponds to a type of dynamically reading data and has a relatively small influence by complexity of image data processing.

According to an embodiment, the processor 410 may analyze the complexity of the image data and determine the division type of the image data based on the analyzed complexity. For example, when the complexity of the image data is small, the processor 410 may determine, as the division type of the image data, the type of dividing the image data sequentially in the horizontal or vertical direction or the type of dividing the image data based on sub sampling. This is because the image data processing load can be relatively reduced due to low complexity of the image data and deterioration of the picture quality can be little through image data processing of low complexity. Alternatively, when the complexity of the image data is large, the processor 410 may determine, as the division type of the image data, the type of dividing the image data based on the complexity. This is because the picture quality may deteriorate when the image data is simply divided.

According to various embodiments, the processor 410 may divide the image data into at least one data block according to the determined division type and then encode the divided data blocks. Further, the processor 410 may perform a decoding for returning the encoded data blocks into the original form.

According to an embodiment, the processor 410 may encode the divided data blocks through the encoding module 420 to generate a plurality of bitstreams and generate header information that stores information on each of the divided data blocks. The processor 410 may store the bitstreams for each of the divided data blocks and the header information as one file and minimize the size of a compressed file. The header information may include division information related to the division of the image data. For example, the division information may include at least one of whether the image data is divided, division type, the number of divided data blocks, the number of columns of the divided data blocks, the number of rows of the divided data blocks, the starting position of the divided data blocks, the column width of the divided data blocks, and the row width of the divided data blocks. The division information may be stored as a part of the image data or additional data other than the image data. For example, the division information may be included in a Supplemental Enhancement Information (SEI) message.

According to an embodiment, the processor 410 may decode the encoded image data through the decoding module 430, configure the decoded image data as one file, and output the configured file to the display 450.

According to an embodiment, based on the header information in the file that stores the divided data blocks and the header information, the processor 410 may decode the encoded image data by identifying information on at least one of whether the image data is divided, the division type, the number of divided data blocks, the number of columns of the divided data blocks, the number of rows of the divided data blocks, the start position of the divided data blocks, the column width of the divided data blocks, and the row width of the divided data blocks.

According to an embodiment, the processor 410 may output the decoded image data to the display 450.

According to various embodiments, the encoding module 420 may encode the divided data blocks provided by the processor 410. For example, the encoding module 420 may be implemented by hardware.

According to various embodiments, the decoding module 430 may decode the encoded image data provided by the processor 410. For example, the decoding module 430 may be implemented by hardware.

According to various embodiments, the memory 440 may be the memory 130 illustrated in FIG. 1. According to an embodiment, the memory 440 may store one file including divided data blocks for the image data having a resolution higher than a resolution supported by the electronic device 401 and header information on each of the data blocks.

According to various embodiments of the present disclosure, the processor 410 may reconfigure the divided data blocks to be successively connected video streams and encode the reconfigured video streams through a video encoding mode. The video encoding mode may be an inter-frame prediction mode.

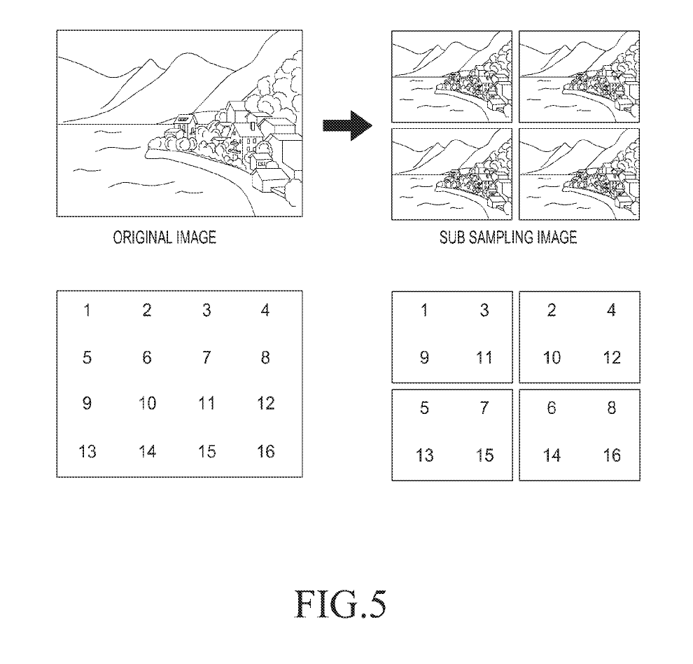

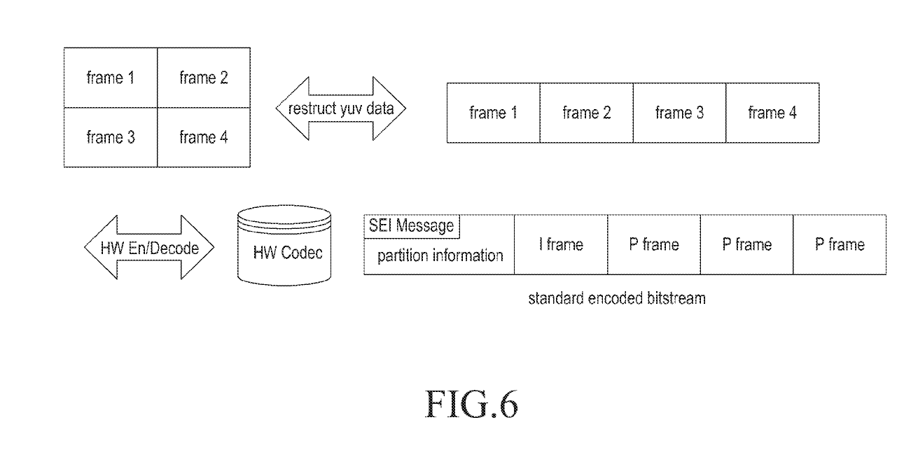

FIG. 5 is a view describing a sub sampling division scheme of image data according to various embodiments of the present disclosure, and FIG. 6 is a view describing a method of reconfiguring divided data blocks of the image to be video streams according to various embodiments of the present disclosure.

According to various embodiments, the processor 410 may divide the image data through a division type based on sub sampling as illustrated in FIG. 5. For example, the type of dividing the image data based on sub sampling may be a division type of image data that may be determined when the image data corresponds to a 8K Ultra High Definition (UHD) image having a resolution of 7680×4320 and a reference solution is 1920×1080. For example, under such a condition, the number of divisions of the image data may be 4. When the image data is divided into 4, the image data may be divided by 4×4 including 1 to 16 elements and the 4 divided data blocks may be generated by grouping elements which are not adjacent to each other. For example, a first data block is a set of elements 1, 3, 9, and 11, a second data block is a set of elements 2, 4, 10, and 12, a third data block is a set of elements 5, 7, 14, and 15, and a fourth data block is a set of elements 6, 8, 14, and 16, and thus the image data may be divided into the 4 data blocks as illustrated in FIG. 5.

According to various embodiments, the processor 410 may divide the image data into 4 data blocks as illustrated in FIG. 6. Further, the processor 410 may reconfigure the 4 divided data blocks to be successively connected video streams. In addition, the processor 410 may generate header information that stores information on each of the divided data blocks. The header information may include division information related to the division of the image data. For example, the division information may include at least one of whether the image data is divided, division type, the number of divided data blocks, the number of columns of the divided data blocks, the number of rows of the divided data blocks, the starting position of the divided data blocks, the column width of the divided data blocks, and the row width of the divided data blocks. The division information may be included in a Supplemental Enhancement Information (SEI) message. The processor 410 may combine the reconfigured video streams and the header information and encode the combined video stream and header information into one file.

According to an embodiment, the processor 410 may encode the reconfigured video streams through the video encoding mode and combine the encoded file and the header information to generate compressed bitstreams. Here, the video encoding mode may be an inter-frame prediction mode.

According to various embodiments of the present disclosure, an electronic device includes: a memory configured to store image data and a resource state of the electronic device; and a processor, and the processor may be configured to determine a division type of the image data based on the image data and the resource state of the electronic device, to divide the image data into at least one data block according to the determined division type, and to generate one file by encoding the at least one divided data block.

According to various embodiments of the present disclosure, when a resolution of the image data is higher than or equal to a reference resolution, the processor may be configured to divide the image data.

According to various embodiments of the present disclosure, the processor may be configured to divide the image data into pieces of image data corresponding to a number rounded up from a value generated by dividing the larger value between the width and the height of the resolution of the image data by the larger value between the width and the height of the reference resolution.

According to various embodiments of the present disclosure, the resource state of the electronic device may include at least one of a temperature of at least some areas of the electronic device, a memory access type, and a number of executed encoder instances.

According to various embodiments of the present disclosure, the processor may be configured to analyze complexity of the image data and to determine the division type of the image data based on the analyzed complexity. Alternatively, the processor may be configured to divide the image data based on an area having low complexity in the analyzed complexity.

According to various embodiments of the present disclosure, the division type of the image data may include at least one of a type of dividing the image data sequentially in a horizontal or vertical direction, a type of dividing the image data based on complexity of the image data, and a type of dividing the image data based on sub sampling.

According to various embodiments of the present disclosure, the processor may be configured to reconfigure the at least one divided data block to be successively connected video streams and to encode the reconfigured video streams by using a video encoding mode. Further, the video encoding mode may be an inter-frame prediction mode.

According to various embodiments of the present disclosure, the processor may be configured to generate header information including division information related to division of the image data and to encode the image data by combining the generated division information. Further, the division information may include at least one of whether the image data is divided, division type, the number of divided data blocks, the number of columns of the divided data blocks, the number of rows of the divided data blocks, the starting position of the divided data blocks, the column width of the divided data blocks, and the row width of the divided data blocks. Further, the division information may be included in a Supplemental Enhancement Information (SEI) message.

According to various embodiments of the present disclosure, the electronic device may further include: an encoding module configured to encode the image data; and a decoding module configured to decode the encoded image data based on header information of the generated file, and each of the encoding module and the decoding module may be implemented by hardware.

According to various embodiments of the present disclosure, the processor may be configured to decode the encoded image data and to output the decoded image data through a display functionally connected to the processor.

According to various embodiments of the present disclosure, an electronic device may include: an encoding module; and a processor, and the processor may be configured to identify a characteristic of image data from the image data, to divide the image data into a first number of areas through a first method when the characteristic meets a first condition, to divide the image data into a second number of areas through a second method when the characteristic meets a second condition, and to generate video encoding streams corresponding to the image data by using one corresponding method between the first method and the second method through the encoding module.

According to various embodiments of the present disclosure, the characteristic may include complexity between a plurality of areas from the image data, and the processor is configured to divide the image data into a predetermined number of areas when the complexity is low and to divide the image data into a plurality of areas based on the complexity when the complexity is high.

According to various embodiments of the present disclosure, the processor may be configured to divide the plurality of areas such that at least one area has an area different from that of the remaining areas.

According to various embodiments of the present disclosure, the processor may be configured to divide the image data based on a resource state of the electronic device. Further, the resource state of the electronic device may include at least one of a temperature of at least some areas of the electronic device, a memory access type, and a number of executed encoder instances.

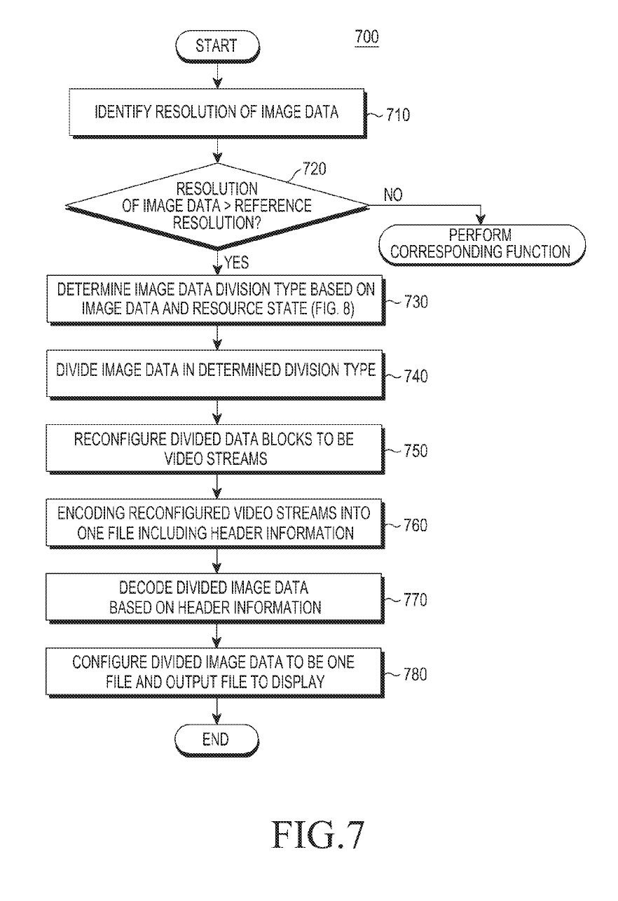

FIG. 7 is a flowchart illustrating an image data processing method according to various embodiments of the present disclosure. In FIG. 7, an image data processing method 700 according to various embodiments may be performed by the processor 410 of the electronic device 401 of FIG. 4 as an example.

Referring to FIG. 7, in operation 710, the electronic device (for example, the processor 410) may identify a resolution of image data which should be processed by the electronic device.

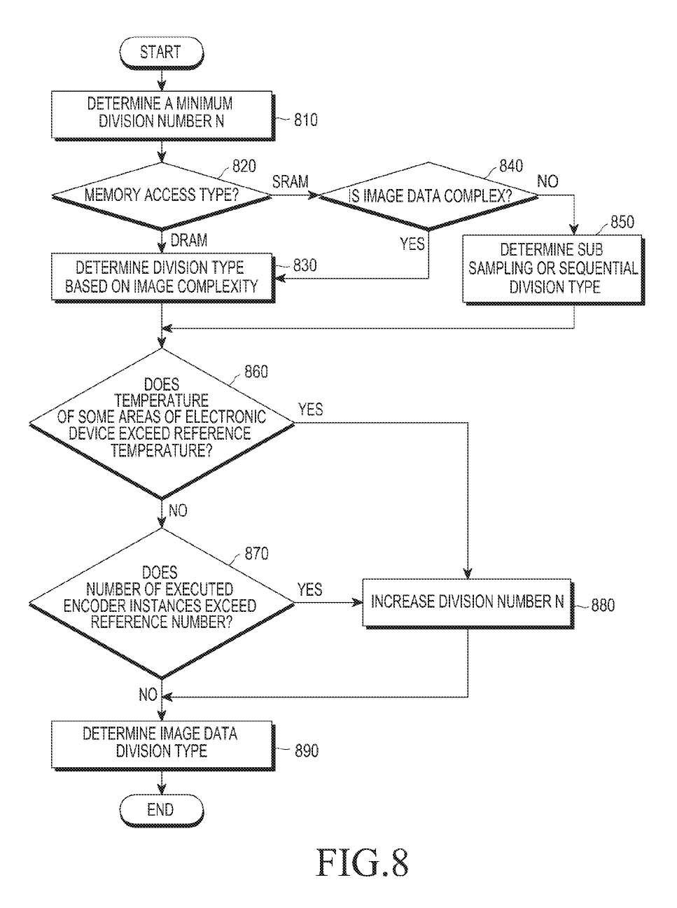

When the electronic device (for example, the processor 410) determines that the identified resolution of the image data is higher than (or higher than or equal to) a reference resolution indicating a resolution which can be supported by the electronic device in operation 720, the electronic device (for example, processor 410) may determine a division type of the image data based on the image data and a state of at least one resource of the electronic device in operation 730. An operation of determining the division type of the image data may be described in detail through FIG. 8.

In operation 740, the electronic device (for example, the processor 410) may divide the image data through the determined division type.

In operation 750, the electronic device (for example, the processor 410) may reconfigure the divided data blocks to be successively connected video streams.

In operation 760, the electronic device (for example, the processor 410) may encode the reconfigured video streams by using the video encoding mode through the encoding module 420. The video encoding mode may be an inter-frame prediction mode. Further, the electronic device (for example, the processor 410) may generate header information including information on each of the divided data blocks. In addition, the header information may include division information related to the division of the image data. For example, the division information may include at least one of whether the image data is divided, division type, the number of divided data blocks, the number of columns of the divided data blocks, the number of rows of the divided data blocks, the starting position of the divided data blocks, the column width of the divided data blocks, and the row width of the divided data blocks. The division information may be included in a Supplemental Enhancement Information (SEI) message. In operation 740, the electronic device (for example, the processor 410) may generate compressed bitstreams by combining the encoded file and the header information.

In operation 770, through the decoding module 430, the electronic device (for example, the processor 410) may identify the information on each of the divided data blocks and the division information related to the division of the image data based on the header information of the file generated in operation 760. In operation 770, the electronic device (for example, the processor 410) may decode the encoded file in the form of video streams based on the header information. Further, the form of video streams may be reconfigured to be divided data blocks. In addition, the reconfigured data blocks may be decoded into the image data. The decoded image data may be data in a YCbCr format.

In operation 780, the electronic device (for example, the processor 410) may configure the decoded image data into one file and output the file to the display 450.

FIG. 8 is a flowchart illustrating a method of determining a division type of image data according to various embodiments of the present disclosure. In FIG. 8, a method 800 of determining a division type of image data according to various embodiments may be performed by the processor 410 of the electronic device 401 of FIG. 4 as an example.

Referring to FIG. 8, in operation 810, when it is determined that a resolution of the image data is higher than or equal to a reference resolution, the electronic device (for example, the processor 410) may divide the image data into a predetermined number of pieces of image data. For example, as shown in equation (1) below, a minimum number of divisions of the image data may be determined as a number rounded up from a value generated by dividing the larger value between the width and the height of the resolution of the image data by the larger value between the width and the height of the reference resolution. For example, when the image data is an 8K Ultra High Definition (UHD) image having a resolution of 7680×4320 and the reference resolution is 1920×1080, the image data may be divided into 4 pieces corresponding to a number rounded up from a value generated by dividing the width 7680, which is the larger value between the width 7680 and the height 4320 of the resolution of the image data, by the width 1920, which is the larger value between the width 1920 and the height 1080 of the reference resolution.

In operation 820, the electronic device (for example, the processor 410) may identify a state of at least one resource of the electronic device 401. In operation 820, the electronic device may identify an access type of the memory 440. When the access type of the memory 440 is a Dynamic Random Access Memory (DRAM) type, the electronic device (for example, the processor 410) may determine, as the division type of the image data, a type of dividing the image data based on data complexity of the image data in operation 830. This is because the DRAM corresponds to a type of dynamically reading data and has a relatively small influence by complexity of image data processing.

Alternatively, in operation 820, the electronic device (for example, the processor 410) may identify the access type of the memory 440. When the access type of the memory 440 is a Static Random Access Memory (SRAM) type, the electronic device (for example, the processor 410) may analyze the complexity of the image data and determine the division type of the image data based on the analyzed complexity in operation 840. When the complexity of the image data is small, the electronic device (for example, the processor 410) may determine, as the division type of the image data, a type of dividing the image data sequentially in a horizontal or vertical direction or a type of dividing the image data based on sub sampling in operation 850. This is because the SRAM corresponds to a type of sequentially reading data and is to relatively reduce the image data processing load since a speed of the image data processing may decrease when complexity of the image data processing is high. In contrast, when the analyzed complexity of the image data is large in operation 840, the electronic device (for example, the processor 410) may determine, as the division type of the image data, the type of dividing the image data based on the complexity of the image data in operation 830.

In operation 860, the electronic device (for example, the processor 410) may identify a temperature (for example, CUP temperature) of at least some areas of the electronic device. When the temperature exceeds a reference temperature, the electronic device (for example, the processor 410) may increase the number of divisions of the image data in operation 880.

In operation 870, the electronic device (for example, the processor 410) may identify the number of encoder instances executed in the electronic device. When the number of encoder instances exceeds a reference number, the electronic device (for example, processor 410) may increase the number of divisions of the image data in operation 880.

When the CPU temperature of the electronic device exceeds the reference temperature or when the number of encoder instances exceeds the reference number, the electronic device (for example, the processor 410) may determine that the electronic device is generally overloaded due to the high CPU temperature or the large number of encoder instances, so that the electronic device (for example, processor 410) increases the number of divisions of the image data to reduce the size of the data blocks in order to relatively decrease the image data processing load in operation 880. In operation 890, the electronic device (for example, the processor 410) may finally determine a maximum number of divisions of the image data and the division type through operations 810 to 880.

According to various embodiments of the present disclosure, a method of processing image data by an electronic device may include: an operation of determining a division type of the image data based on the image data and a resource state of the electronic device by the electronic device; an operation of dividing the image data into at least one data block according to the determined division type; and an operation of generating one file by encoding the at least one divided data block.

According to various embodiments of the present disclosure, the operation of dividing the image data may include an operation of dividing the image data when a resolution of the image data is higher than or equal to a reference resolution.

According to various embodiments of the present disclosure, the method may further include: the operation of reconfiguring the at least one divided one data block to be successively connected video streams; and operation of encoding the reconfigured video streams by using a video encoding mode.

According to various embodiments of the present disclosure, the method may further include: the operation of generating header information including division information related to division of the image data; and an operation of encoding the image data by combining the generated division information.

According to various embodiments of the present disclosure, the operation of encoding the image data and the decoding of the encoded image data and the operation of decoding the encoded image data may be performed by an encoding module and a decoding module implemented by hardware. Further, the method may further include an operation of decoding the encoded image data and outputting the decoded image data to a display based on header information of the generated file.

According to various embodiments of the present disclosure, a computer recording medium executed by at least one processor and storing computer-readable instructions is provided. The instructions may include: an operation of determining a division type of image data based on the image data and a resource state of an electronic device; an operation of dividing the image data into at least one data block according to the determined division type; and an operation of generating one file by encoding the at least one divided data block.

Although the present disclosure has been described with various exemplary embodiments, various changes and modifications may be suggested to one skilled in the art. It is intended that the present disclosure encompass such changes and modifications as fall within the scope of the appended claims.

What is claimed is:

1. An electronic device comprising:
a memory configured to store image data and a resource state of the electronic device; and
a processor, configured to:
determine a division type of the image data based on the image data and the resource state of the electronic device,
divide the image data into at least one data block according to the determined division type, and
generate one file by encoding the divided image data.

2. The electronic device of claim 1, wherein the processor is configured to:
in response to a resolution of the image data being higher than or equal to a reference resolution, divide the image data.

3. The electronic device of claim 2, wherein the processor is configured to divide the image data into pieces of image data corresponding to a number that is rounded up from a value generated by dividing a first value by a second value,
wherein the first value is a larger value between a width and a height of the resolution of the image data, and
wherein the second value is a larger value between a width and a height of the reference resolution.

4. The electronic device of claim 1, wherein the resource state of the electronic device includes at least one of a temperature of at least some areas of the electronic device, a memory access type, and a number of executed encoder instances.

5. The electronic device of claim 1, wherein the processor is configured to:
reconfigure the at least one divided data block to be successively connected video streams, and
encode the reconfigured video streams by using a video encoding mode.

6. The electronic device of claim 5, wherein the video encoding mode is an inter-frame prediction mode.

7. The electronic device of claim 1, wherein the processor is configured to:
generate header information including division information related to division of the image data, and
encode the image data by combining the generated division information.

8. The electronic device of claim 7, wherein the division information includes at least one of whether the image data is divided, a number of divided data blocks, a number of columns of the divided data blocks, a number of rows of the divided data blocks, a start position of the divided data blocks, a column width of the divided data blocks, and a row width of the divided data blocks.

9. The electronic device of claim 8, wherein the division information is configured to be included in a Supplemental Enhancement Information (SEI) message.

10. The electronic device of claim 1, further comprising:
an encoding module configured to encode the image data; and
a decoding module configured to decode the encoded image data based on header information of the generated file,
wherein each of the encoding module and the decoding module is implemented by hardware.

11. The electronic device of claim 1, wherein the processor is configured to decode the encoded divided image data and to output the decoded divided image data through a display functionally connected to the processor.

12. A method of processing image data by an electronic device, the method comprising:
determining, by the electronic device, a division type of the image data based on the image data and a resource state of the electronic device;
dividing the image data into at least one data block according to the determined division type; and
generating one file by encoding the divided image data.

13. The method of claim 12, further comprising dividing the image data when a resolution of the image data is determined to be higher than or equal to a reference resolution.

14. The method of claim 12, further comprising:
reconfiguring the at least one divided data block to be successively connected video streams; and
encoding the reconfigured video streams by using a video encoding mode.

15. The method of claim 12, further comprising:
generating header information including division information related to division of the image data; and
encoding the image data by combining the generated division information.

16. An electronic device comprising:
an encoding module; and
a processor, configured to:
identify a characteristic of image data from the image data,
divide the image data into a first number of areas through a first method when the characteristic meets a first condition,
divide the image data into a second number of areas through a second method when the characteristic meets a second condition, and
generate, through the encoding module, video encoding streams corresponding to the image data by using one of the first method and the second method.

17. The electronic device of claim 16, wherein the identified characteristic includes complexity between a plurality of areas from the image data, and the processor is configured to:
in response to the image data having a low threshold complexity, divide the image data into a predetermined number of areas, and
in response to the image data having a complexity higher than the low threshold complexity, divide the image data into a plurality of areas based on the complexity.

18. The electronic device of claim 17, wherein the processor is configured to divide the image data into the plurality of areas such that at least one area of the plurality of areas includes an area different from that of the remaining areas.

19. The electronic device of claim 16, wherein the processor is configured to divide the image data based on a resource state of the electronic device.

20. The electronic device of claim 19, wherein the resource state of the electronic device includes at least one of a temperature of at least some areas of the electronic device, a memory access type, and a number of executed encoder instances.
